(19) United States
(12) Patent Application Publication
(10) Pub. No.: US 2022/0006182 A1
(43) Pub. Date: Jan. 6, 2022

(54) RADIATOR FOR ANTENNA AND BASE STATION ANTENNA

(71) Applicant: CommScope Technologies LLC, Hickory, NC (US)

(72) Inventors: Xun ZHANG, Suzhou (CN); Bo WU, Suzhou (CN); Xiaotuo WANG, Suzhou (CN); Ligang WU, Suzhou (CN)

(21) Appl. No.: 17/292,569

(22) PCT Filed: Jan. 30, 2020
(86) PCT No.: PCT/US2020/015772

§ 371 Date: May 10, 2021

(30) Foreign Application Priority Data
Feb. 26, 2019 (CN) 201910141738.2

(51) Int. Cl. H01Q 1/52; H01Q 1/08; H01Q 19/10; H01Q 1/24; H01Q 9/28; H01Q 1/38; H01Q 21/26

(52) U.S. Cl. CPC H01Q 1/523; H01Q 1/08; H01Q 19/108; H01Q 21/26; H01Q 9/285; H01Q 1/38; H01Q 1/246

(57) ABSTRACT

A radiator for an antenna comprises a radiating element having a radiating arm and a feed portion and a first dielectric structure configured to cover at least 50% of the radiating element, the dielectric structure having a dielectric constant of at least 3.0. The dielectric structure reduces a first electrical length of the radiating arm by at least 20% and also reduces a second electrical length of the feed portion by at least 20%.

### CROSS-REFERENCE TO RELATED APPLICATION

The present application claims priority to Chinese Patent Application No. 201910141738.2, filed Feb. 26, 2019, the entire content of which is incorporated herein by reference as if set forth fully herein.

### FIELD

The present invention relates generally to cellular communications systems and, more particularly, to radiators for base station antennas. In addition, the present invention also relates to base station antennas including a plurality of these radiators

### BACKGROUND

Multiple-Input Multiple-Output (MIMO) antenna systems are a core technology for next-generation mobile communications. MIMO antenna systems use multiple arrays of radiating elements for transmission and/or reception in order to improve communication quality. However, as the number of arrays of radiating elements mounted on a reflecting plate or “reflector” of an antenna increases, the spacing between radiating elements of adjacent arrays is typically decreased, which results in increased coupling interference between the arrays. The increased coupling interference degrades the isolation performance of the radiating elements, which may negatively affect the radiation patterns or “antenna beams” that are formed by the arrays of radiating elements.

### SUMMARY

According to a first aspect of the present invention, a radiator for an antenna is provided. The radiator comprises a radiating element having a radiating arm and a feed portion, characterized in that the radiator further comprises a first dielectric structure configured to cover at least 50% of a corresponding radiating element, the dielectric structure having a dielectric constant of at least 3.0.

In some embodiments, the radiating arm has a first major surface and a second major surface opposite the first major surface, and the first dielectric structure is configured to at least partially cover the first major surface and/or the second major surface of the corresponding radiating arm.

In some embodiments, the first dielectric structure is configured to substantially completely cover the first major surface and/or the second major surface of the corresponding radiating arm.

In some embodiments, the radiating arm and the feed portion are a monolithic structure.

In some embodiments, the radiating arm and the feed portion comprise a piece sheet metal.

In some embodiments, the radiating arm and the feed portion are constructed as a one-piece printed circuit board component.

In some embodiments, the first dielectric structure abuts the corresponding radiating element.

In some embodiments, the first dielectric structure is a separate piece from the corresponding radiating element.

In some embodiments, the coverage area of the first dielectric structure is adjustable.

In some embodiments, the radiator further comprises a second dielectric structure that is disposed between two adjacent radiating arms.

In some embodiments, the second dielectric structure is fixed to at least one of the radiating arm, the feed portion, a base, and a reflecting plate.

In some embodiments, a length that the second dielectric structure extends between two adjacent radiating arms is adjustable.

In some embodiments, a position of the second dielectric structure between two adjacent radiating arms is adjustable.

In some embodiments, a plurality of engagement openings that are provided in the reflecting plate are spaced apart from one another, and are configured for installation of a plurality of second dielectric structures.

In some embodiments, a feed portion dielectric structure is provided around the feed portion.

In some embodiments, the first dielectric structure has a dielectric constant between 3 and 40.

In some embodiments, the second dielectric structure has a dielectric constant between 3 and 40.

According to a second aspect of the present invention, there is provided a radiator for an antenna. The radiator comprises a radiating element having a radiating arm and a feed portion. The radiator further comprises a dielectric structure that reduces a first electrical length of the radiating arm by at least 20% and that also reduces a second electrical length of the feed portion by at least 20%.

In some embodiments, the dielectric structure reduces the first electrical length of the radiating arm between 60% and 80%, and/or reduces the second electrical length of the feed portion between 60% and 80%.

In some embodiments, the radiating arm and the feed portion are a monolithic component.

In some embodiments, the radiating arm and the feed portion comprise a piece of sheet metal.

In some embodiments, the radiating arm and the feed portion are constructed as a one-piece printed circuit board component.

In some embodiments, the dielectric structure covers at least 50% of each major surface of the radiating element.

In some embodiments, the dielectric structure substantially completely covers both first and second major surfaces of the radiating element.

According to a third aspect of the present invention, there is provided a radiator for an antenna. The radiator comprises a radiating element including a radiating arm and a feed portion each having a first major surface and a second major surface opposite the first major surface. The radiator further comprises a dielectric structure which includes a dielectric support that is separate from the radiating element that at least partially covers the first major surface of the radiating arm and/or the feed portion, and a dielectric cover that is separate from the radiating element that at least partially covers the second major surface of the radiating arm and/or the feed portion.

In some embodiments, the radiator further includes a base, where the dielectric support engages the base.

In some embodiments, the radiating arm and the feed portion are a monolithic component.

In some embodiments, the radiating arm and the feed portion comprise a piece of sheet metal.

In some embodiments, the radiating arm and the feed portion are constructed as a one-piece printed circuit board component.

In some embodiments, the dielectric support has at least one limiting portion for pre-fixing the radiating arm.

In some embodiments, the dielectric support, the dielectric cover, and the radiating arm and/or the feed portion are each provided with a respective rivet hole.

In some embodiments, in the respective rivet holes are provided dielectric rivets, which pass through the dielectric support and the dielectric cover as well as the radiating arm and/or the feed portion.

In some embodiments, the dielectric cover has an engaging portion configured to engage the dielectric support, so as to cover the radiating element on both sides.

In some embodiments, the engaging portion is constructed as a hook portion configured to fasten the dielectric cover with the dielectric support.

According to a fourth aspect of the present invention, a base station antenna is provided, which comprises a reflecting plate and an array of radiators disposed on the reflecting plate, wherein the radiator in the array of radiators is configured as the radiator according to the present invention.

### BRIEF DESCRIPTION OF THE DRAWING

FIG. 1 is a perspective view of a radiator according to embodiments of the present invention.

FIG. 2a is a schematic perspective view of a dielectric support of the radiator of FIG. 1.

FIG. 2b is a schematic perspective view of a radiating arm of the radiator of FIG. 1.

FIG. 2c is a schematic perspective view of a dielectric cover of the radiator of FIG. 1.

FIG. 3a is a schematic top view of another radiator according to embodiments of the present invention.

FIG. 3b is a schematic top view of a variation of the radiator of FIG. 3a.

FIG. 3c is a schematic top view of another variation of the radiator of FIGS. 3a and 3b.

### DETAILED DESCRIPTION

Embodiments of the present invention will be described below with reference to the drawings, in which several embodiments of the present invention are shown. It should be understood, however, that the present invention may be implemented in many different ways, and is not limited to the example embodiments described below. In fact, the embodiments described hereinafter are intended to make a more complete disclosure of the present invention and to adequately explain the scope of the present invention to a person skilled in the art. It will also be understood that, the embodiments disclosed herein can be combined in various ways to provide many additional embodiments.

It should be understood that, the wording in the specification is only used for describing particular embodiments and is not intended to limit the present invention. All the terms used in the specification (including technical and scientific terms) have the meanings as normally understood by a person skilled in the art, unless otherwise defined. For the sake of conciseness and/or clarity, well-known functions or constructions may not be described in detail.

The singular forms “a/an” and “the” as used in the specification, unless clearly indicated otherwise, all contain the plural forms. The words “comprising”, “containing” and “including” when used in the specification indicate the presence of the claimed features, but do not preclude the presence of one or more additional features. The wording “and/or” as used in the specification includes any and all combinations of one or more of the items listed.

In the specification, words describing spatial relationships such as “up”, “down”, “left”, “right”, “front”, “back”, “high”, “low” and the like may describe a relationship of one feature to another feature in the drawings. It should be understood that these terms also encompass different orientations of the apparatus in use or operation, in addition to encompassing the orientations shown in the drawings. For example, when the apparatus shown in the drawings is turned over, the features previously described as being “below” other features may be described to be “above” other features at this time. The apparatus may also be otherwise oriented (rotated 90 degrees or at other orientations) and the relative spatial relationships will be correspondingly altered.

It should be understood that, in all the drawings, the same reference signs refer to the same elements. In the drawings, for the sake of clarity, the sizes of certain features may be modified.

Embodiments of the present invention will now be described in more detail with reference to the accompanying drawings, in which exemplary embodiments are described.

A base station antenna generally consists of arrays of radiators, feed networks and phase shift networks. An important parameter for a base station antenna is the width of the antenna, which refers to the dimension of the front surface of the antenna in a plane parallel to the horizon when the base station antenna is mounted for use. Cellular operators typically want to limit the width of the antenna to be for example, less than 440 mm or, more preferably, less than 400 mm, as larger width antennas are considered unaesthetic, may violate local zoning ordinances, and/or may have high levels of wind loading. However, as noted above, the trend now is to increase the number of arrays of radiators in base station antennas, and hence to keep the width of these antennas within reason, it generally becomes necessary to space the arrays of radiators closer together.

Each array of radiators included in a base station antenna is typically designed to operate in a pre-defined frequency range. Most arrays of radiators are designed to operate in at least portions of one or more of three wide frequency bands, that is, a low-band frequency range that extends from 617 MHz to 960 MHz, a mid-band frequency range that extends from 1690 MHz to 2690 MHz, and a high-band frequency range that extends from 3.3 GHz to 5.8 GHz. In addition, an ultra-wideband radiator is configured to operate in a wide-band frequency range that extends from approximately 1.4 GHz to 2.7 GHz.

The operating frequency range of an array of radiators of a base station antenna will be a function of the frequency range over which the radiator achieves suitable impedance matching. In order to exhibit suitable impedance matching for a specific frequency range, the radiating arms of the radiator may need to be a specific electrical length, and the feed portion of the radiator may need to be a specific electrical height. Generally, in the case where the radiator is a half-wavelength radiator, the impedance matching can be achieved when the length of each radiating arm of the radiator and the height of the feed portion of the radiator above the reflector each are about one quarter of the wavelength corresponding to a center frequency of the desired operating frequency range. It can be seen that the requirement for size of the radiators and the requirement for impedance matching of the radiators can be contradictory with each other. Thus, a challenge to those skilled in the art is how to balance the size and operating frequency range of the radiators.

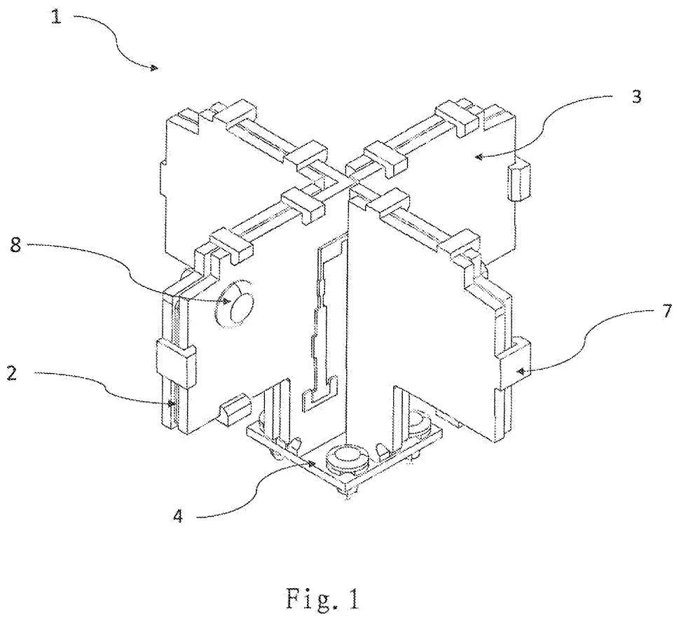

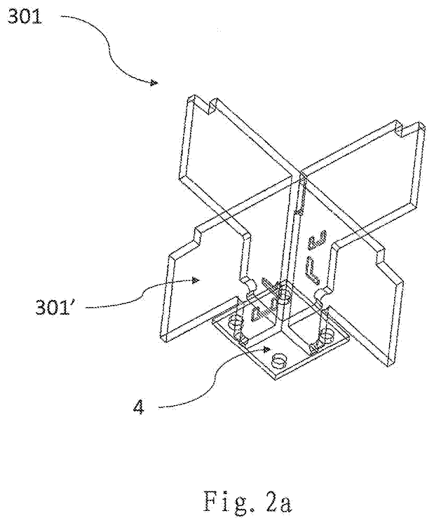

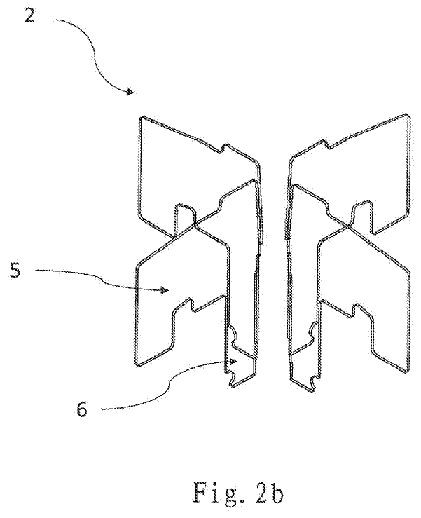

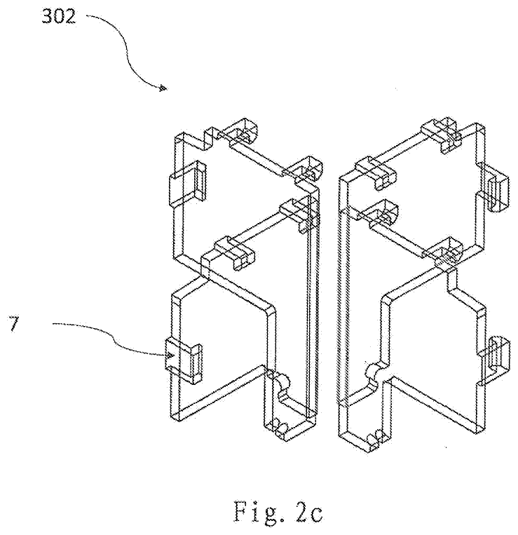

Now, a radiator according to embodiments of the present invention will be described with reference to FIGS. 1, 2a, 2b and 2c.

In the present embodiment, a radiator 1 may be constructed as a dual-polarized dipole radiator. The radiator 1 comprises radiating elements 2, dielectric structures 3 and a base 4. Four radiating elements 2 are disposed to cross each other to form two pairs of crossed dipoles. Each of the radiating elements 2 is positioned within the dielectric structure 3 and fixed to the base 4 together with the dielectric structure 3.

A specific configuration of the radiator 1 according to embodiments of the present invention may be further seen from FIGS. 2a, 2b and 2c.

In the present embodiment, the dielectric structure 3 includes a dielectric support 301 and a dielectric cover 302. As can be seen from FIG. 2a, the dielectric support 301 may be integrally formed and fixed to the base 4. The dielectric support 301 includes four support arms 301′ in crossing distribution, each of which corresponds to one radiating element of the four radiating elements 2, that is, each support arm 301′ is configured to support one of the radiating elements 2.

As can be seen from FIG. 2b, in the present embodiment, each radiating element 2 comprises a radiating arm 5 and a feed portion 6. The radiating element 2 may be constructed as a metal radiating element (for example, a metal radiating plate or a metal radiating sheet made of copper, aluminum, alloys thereof or the like), and the radiating arm 5 and the feed portion 6 of the radiating element 2 may be integrally formed.

In the present embodiment, the four radiating elements 2 are constructed separately. Each radiating element 2 is supported on a corresponding dielectric support 301. For example, each dielectric support 301 may be provided with, for example a receiving recess, for pre-fixing the radiating element 2. In this way, the dielectric support 301 is able to cover the first major surface of the radiating element 2. Further, a dielectric cover 302 may be provided over a second major surface of the radiating element 2 opposite the first major surface so as to cover the second major surface of the radiating element 2. As can be seen from FIG. 1, the dielectric support 301 and the dielectric cover 302 may substantially completely cover the radiating arm 5 and the feed portion 6 of the radiating element 2. In other embodiments, the dielectric support 301 and the dielectric cover 302 may alternatively cover only the radiating arm 5 or only the feed portion 6 of the radiating element 2. In other embodiments, the dielectric support 301 and the dielectric cover 302 may cover only a portion of the radiating arm 5 and/or a portion of the feed portion 6 of the radiating element 2. In some embodiments, the coverage area of the dielectric support 301 and the dielectric cover 302 over the radiating element 2 may be adjustable. The dielectric structure 3 may, for example, be designed as a foldable or a telescopic structure.

As can be seen from FIG. 2c, in the present embodiment, four separate dielectric covers 302 are provided. Each dielectric cover 302 corresponds to a radiating element 2 and is configured to cover the second major surface of the radiating element 2. Further, the dielectric cover 302 also has an engaging portion 7 configured to engage the dielectric support 301 with the radiating element 2 therebetween. The engaging portion 7 may, for example, be constructed as a hook portion. As can be seen from FIGS. 1 and 2c, a plurality of hook portions are provided on different side edges of the dielectric cover 302, and each of the hook portions is configured to fasten the dielectric support 301 and the dielectric cover 302 together. In this way, a sandwich-like unit consisting of the dielectric support 301, the radiating element 2 and the dielectric cover 302 is formed.

In the present embodiment, the dielectric structure 3 may be formed of plastic. In other embodiments, the dielectric structure 3 may be formed of other materials, such as fiberglass or ceramic. Preferably, the dielectric structure 3 may have a dielectric constant between 3 and 40. It is also possible that the dielectric constant is less than 3 or greater than 40. In this way, the equivalent dielectric constant of the equivalent radiator formed by the radiating elements 2 in combination with the dielectric structures 3 is significantly increased, and hence current distribution characteristics (e.g., wavelength) may be effectively varied, and miniaturization of the radiator 1 may be realized.

Further, as also can be seen from FIG. 1, rivet holes 8 may be provided at corresponding positions of the dielectric supports 301, the radiating elements 2, and the dielectric covers 302. During mounting, the rivet holes in each radiating element 2 are first aligned with the rivet holes in the corresponding dielectric support 301, thereby achieving pre-location of the radiating element 2, wherein the radiating element 2 may also preferably be pre-fixed in the receiving recess of the dielectric support 301; then, the dielectric cover 302 is mounted to the corresponding dielectric support 301 by, for example, its hook portions (at this time, the rivet holes in the dielectric cover 302 are aligned with the rivet holes in the dielectric support 301 and the radiating element 2); finally, rivets (particularly plastic or other dielectric rivets) are sequentially passed through the dielectric cover 302, the radiating element 2 and the dielectric support 301, thereby enhancing the engagement therebetween, ensuring that the radiating element 2 can be reliably held within the dielectric structure 3.

Alternatively or additionally, screw holes may be provided in each dielectric support 301, dielectric cover 302, and radiating arm 5 and/or in each feed portion 6. For example plastic screws may pass through the respective screw holes in sequence, thereby reliably engaging the dielectric cover 302, the radiating element 2 and the dielectric support 301 to affix these elements to one another.

In other embodiments, each radiating element 2 may be constructed as a printed circuit board component, in which the radiating arm 5 and the feed portion 6 are printed on a dielectric support 301. In addition, other signal transmission circuits, filter circuits, and the like may also be printed in the printed circuit board component.

In other embodiments, the radiating elements 2 may be fixedly connected to the base 4. The dielectric structure 3 is mounted to the corresponding radiating element 2. For example, a plurality of dielectric structures 3 may be provided, each of which is engaged to the radiating element 2 or to a different region of the radiating element 2 (for example, to the radiating arm 5 and the feed portion 6).

In other embodiments, the dielectric structure 3 is constructed as a hollow base (particularly an integrally formed hollow base) that is fixedly disposed on the base 4. The corresponding radiating elements 2 may be inserted into the hollow base so that the dielectric structures 3 cover the respective radiating elements 2.

It should be noted that the radiating elements 2 and the dielectric structure 3 may have any suitable configuration to form the radiator 1 according to the present invention, not limited to the configuration exemplarily described in the embodiments of the present invention.

The radiator 1 according to the embodiments of the present invention is advantageous in that the volume of the radiator 1 can be significantly reduced while still providing a radiator 1 that can operate over the full operating frequency range. Further, the engagement manner of the dielectric structure 3 with the radiating element 2 in the radiator 1 according to embodiments of the present invention is also advantageous in that the dielectric structure 3 can cover both the radiating arm 5 and the feed portion 6 of the radiating element 2. This simplifies the mounting process and reduces costs.

In the present embodiment, the dielectric structures 3 substantially completely cover the corresponding radiating elements 2. In other words, each dielectric structure 3 covers not only the radiating arm 5 but also the feed portion 6 of its associated radiating element 2. In other embodiments, the dielectric structure 3 may only partially cover its associated radiating element 2. The dielectric structure 3 may, for example, cover only one major surface of the radiating element 2. The dielectric structure 3 may also, for example, cover only a part of the surface of the radiating element 2 (for example, 60% of the surface). Further, the coverage area of the dielectric structure 3 may also be diverse, thereby able to well adapt to the actual application situations. Technicians may simulate various coverage areas or materials with different dielectric constant at the beginning of the design so as to perform a preliminary test on the function of the radiator 1, and may further make a flexible modification based on the test results.

With respect to a conventional radiator having half-wave dipoles, the length of each radiating arm is substantially one quarter of the wavelength corresponding to a center frequency of an operating band of the radiator (referred to as a center wavelength); likewise, the height of the feed portion thereof may be substantially one quarter of the center wavelength. With respect to the radiator 1 according to the embodiments of the present invention, based on a variation of current distribution characteristics caused by the dielectric structure 3, the length of each radiating arm 5 of the radiating element 2 may be less than one quarter of the center wavelength, for example, reduced to 0.2 times of the center wavelength, and the height of the feed portion 6 of the radiating element 2 may also be less than one quarter of the center wavelength, for example, reduced to 0.15 times of the center wavelength. It can be seen that the size of the radiator 1 according to the embodiments of the present invention is reduced, thereby increasing the spacing between adjacent radiators 1, whereby the coupling interference between the radiators 1 is reduced and the isolation effect is improved.

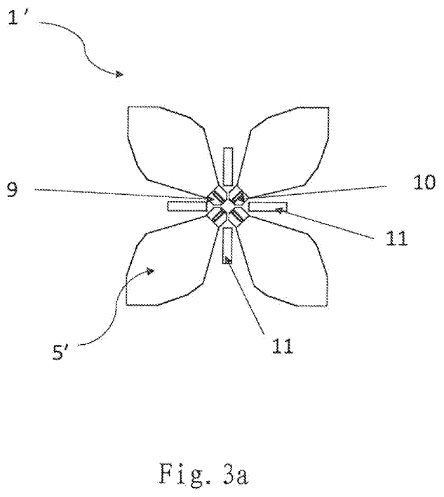

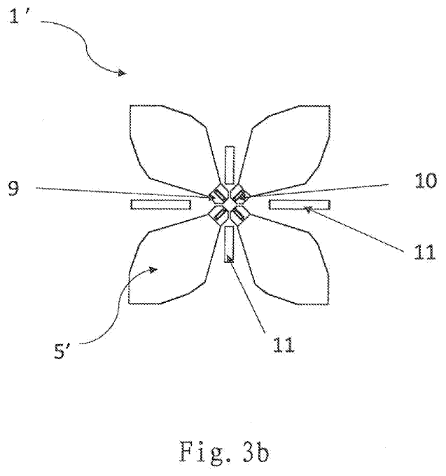

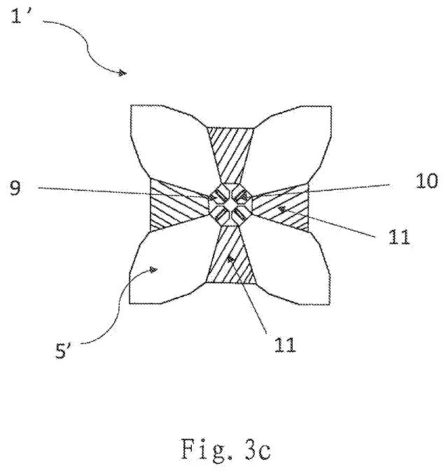

Next, another radiator 1′ according to embodiments of the present invention will be described with reference to FIGS. 3a, 3b and 3c.

The radiator 1′ is also implemented as a dual-polarized dipole radiator. As can be seen from the top views, the radiator 1′ comprises four radiating arms 5′ (which constitute two pairs of dipoles) that may extend, for example, parallel to the reflector. A feed end 9 is provided on an inner end of each radiating arm 5′, with an engaging groove 10 provided in the feed end 9. The feed portions (not shown here) extend forwardly from the reflector and may be inserted into the corresponding engaging grooves 10 such that each radiating arm 5′ is supported on its corresponding feed portion.

In the present embodiment, the four radiating arms 5′ may be constructed separately and may be constructed as metal radiating arms respectively (for example, metal radiating arms formed of copper, aluminum, alloys thereof, or the like). In order to reduce the size of the radiator 1′, a corresponding dielectric structure (here is not shown) may be mounted on the metal radiating arm. For example, a corresponding dielectric cover may be mounted on the metal radiating arm as mentioned above. In addition, it is also possible to spray a layer of dielectric material on the metal radiating arm, for example, by a spraying process. Based on the variation of current distribution characteristics caused by the dielectric structure or the dielectric material, the length of the radiating arm 5′ may be less than one quarter of the center wavelength, for example, reduced to 0.2 times of the center wavelength. The smaller radiating arms 5′ increases the spacing between radiators 1′ in adjacent arrays, and hence reduces the coupling interference between the radiators 1′ and improves the isolation effect.

Further, in order to reduce the extent to which the radiator 1′ extends forwardly from the reflector, it is also feasible to reduce the depth of the feed portion (i.e., the length of the feed portion in the forward direction). For example, the depth of the feed portion of radiator 1′ may be less than one quarter of the center wavelength, for example, reduced to 0.15 times of the center wavelength. However, due to the reduction in the depth of the feed portion, the distance between the radiating arm 5′ supported on the feed portion and the reflector is reduced, which varies the current distribution and increases the difficulty of matching the feed portion to a 50 ohm impedance of an RF transmission line that may provide RF signals to the feed portion.

In order to compensate for the variation of current distribution caused by shortening of the feed portion, it is also possible to provide a dielectric structure 11 between two adjacent radiating arms 5′. Referring to FIG. 3a, in this embodiment, a strip-shaped dielectric structure 11 is provided between two adjacent radiating arms 5′, respectively. Each of the dielectric structures 11 may be, for example, fixedly disposed on the reflecting plate. The introduction of the dielectric structures 11 in the vicinity of the radiating arm 5′ and the feed portion of the radiator 1′ compensates for the resulting variation of the current distribution, and improves the impedance matching of the radiator F.

Preferably, the extension length and/or position of the dielectric structure 11 between two adjacent radiating arms 5′ is adjustable. Referring to FIG. 3b, in this embodiment, the dielectric structures 11 on left and right sides are farther away from the feed ends 9 of the radiating arms 5′ than the dielectric structures 11 on the front and rear sides. Further, it can also be seen that the dielectric structures 11 on the left and right sides are designed to be longer than the dielectric structures 11 on the top and bottom sides. Further, in order to enable the dielectric structures 11 to be disposed at different locations, a plurality of engaging openings spaced apart from one another may be provided in the reflecting plate for mounting of the corresponding dielectric structures 11. Thus, the performance of the radiator 1′ may be debugged at different locations, improving the debugging flexibility for the radiator P. It should be noted that the specific shape and size (such as length, width and thickness) of the dielectric structures 11 may be arbitrarily designed according to the specific application situations.

Alternatively or additionally, the dielectric structures 11 may also be fixed to the radiating arms 5′ or the feed portion of the radiator F. Referring to FIG. 3c, in this embodiment, the dielectric structure 11 is filled between two adjacent radiating arms 5′. The four dielectric structures 11 may be, for example, fixedly connected to or integrally formed with the radiating arms 5′. In other embodiments, the dielectric structures 11 may also be fixed to corresponding feed portions. It is possible that a peripheral edge of the feed portion is provided with dielectric structures (for example, mounting a dielectric hood or spraying a layer of dielectric material).

The radiator 1′ according to the present invention is advantageous in that the volume of the radiator 1′ can be significantly reduced while maintaining a good bandwidth performance, and the radiator 1′ is simple in structure, easy to install, and flexible to debug.

Although the specific embodiments of the present disclosure have been described in detail by way of example, those skilled in the art should understand that the above examples are for illustrative purposes only and are not intended to limit the scope of the present disclosure. The various embodiments disclosed herein may be combined in any combination without departing from the spirit and scope of the disclosure. It should also be understood by those skilled in the art that various modifications may be made in the embodiments without departing from the scope and spirit of the disclosure.

1. A radiator for an antenna, comprising:
a radiating element having a radiating arm and a feed portion, and
a first dielectric structure mounted on the radiating element that covers at least 50% of the radiating element, the dielectric structure having a dielectric constant of at least 3.0.

2. The radiator for an antenna according to claim 1, wherein the radiating arm has a first major surface and a second major surface opposite the first major surface, and the first dielectric structure at least partially covers the first major surface and/or the second major surface of the corresponding radiating arm.

3. (canceled)

4. The radiator for an antenna according to claim 1, wherein the radiating arm and the feed portion are a monolithic structure.

5. The radiator for an antenna according to claim 4, wherein the radiating arm and the feed portion comprise a piece sheet metal.

6. The radiator for an antenna according to claim 4, wherein the radiating arm and the feed portion are constructed as a one-piece printed circuit board component.

7-8. (canceled)

9. The radiator for an antenna according to claim 1, wherein the coverage area of the first dielectric structure is adjustable.

10. The radiator for an antenna according to claim 1, wherein the radiator further comprises a second dielectric structure disposed between two adjacent radiating arms.

11. The radiator for an antenna according to claim 10, wherein the second dielectric structure is fixed to at least one of the radiating arm, the feed portion, a base, and a reflecting plate.

12. The radiator for an antenna according to claim 10, wherein a length that the second dielectric structure extends between two adjacent radiating arms is adjustable.

13. The radiator for an antenna according to claim 10, wherein a position of the second dielectric structure between two adjacent radiating arms is adjustable.

14. (canceled)

15. The radiator for an antenna according to claim 1, wherein a feed portion dielectric structure is provided around the feed portion.

16-17. (canceled)

18. A radiator for an antenna, comprising:
a radiating element having a radiating arm and a feed portion; and
a dielectric structure that reduces a first electrical length of the radiating arm by at least 20% and that also reduces a second electrical length of the feed portion by at least 20%.

19. The radiator for an antenna according to claim 18, wherein the dielectric structure reduces the first electrical length of the radiating arm between 60% and 80%, and/or reduces the second electrical length of the feed portion between 60% and 80%.

20-22. (canceled)

23. The radiator for an antenna according to claim 18, wherein the dielectric structure covers at least 50% of each major surface of the radiating element.

24. (canceled)

25. A radiator for an antenna, comprising:
a radiating element including a radiating arm and a feed portion each having a first major surface and a second major surface opposite the first major surface;
a dielectric structure which includes a dielectric support that is separate from the radiating element that at least partially covers the first major surface of the radiating arm and/or the feed portion; and
a dielectric cover that is separate from the radiating element that at least partially covers the second major surface of the radiating arm and/or the feed portion.

26. The radiator for an antenna according to claim 25, wherein the radiator further includes a base, where the dielectric support engages the base.

27. The radiator for an antenna according to claim 25, wherein the radiating arm and the feed portion are a monolithic component.

28. The radiator for an antenna according to claim 27, wherein the radiating arm and the feed portion comprise a piece of sheet metal.

29. The radiator for an antenna according to claim 27, wherein the radiating arm and the feed portion are constructed as a one-piece printed circuit board component.

30-32. (canceled)

33. The radiator for an antenna according to claim 25 or 26, wherein the dielectric cover has an engaging portion configured to engage the dielectric support, so as to cover the radiating element on both sides.

34-35. (canceled)
